(19) United States
(12) Patent Application Publication
(10) Pub. No.: US 2007/0156342 A1
(43) Pub. Date: Jul. 5, 2007

(54) Pseudo-sequence method for comparing 7tm receptors with respect to the physico-chemical properties of their binding sites

(75) Inventors: Thomas M. Frimurer, Copenhagen S (DK); Trond Ulven, Copenhagen K (DK); Thomas Hogberg, Akarp (SE); Christian E. Elling, Horsholm (DK)

Correspondence Address: EDWARDS ANGELL PALMER & DODGE LLP, P.O. BOX 55874, BOSTON, MA, 02205, US

(73) Assignee: 7TM PHARMA A/S, HORSHOLM (DK)

(21) Appl. No.: 10/547,944

(22) PCT Filed: Mar. 5, 2004
(86) PCT No.: PCT/DK04/00148

§ 371 Date: Jul. 10, 2006

(30) Foreign Application Priority Data
Mar. 7, 2003 (DK) PA 2003 00353

(51) Int. Cl. G06F 19/00; G06G 7/48

(52) U.S. Cl. 702/19; 702/20; 703/11

(57) ABSTRACT

A pseudo-sequence method for comparing 7TM receptors with respect to the physicochemical properties of their binding sites, the method comprising the steps of: (i) optionally, aligning part of or all of the amino acid sequence of the first 7TM receptor with part of or all or the amino acid sequence of the one or more further 7TM receptors, (ii) selecting, in a sequential or non-sequential order, at the most 12 amino acid residues per helix and/or extracellular loops, which are involved in one or more binding sites of each 7TM receptor. (iii) forming a pseudo-sequence comprising at the most 50 amino acid residues from the selected sequential or non-sequential amino acid residues, (iv) for each 7TM receptor assigning one or more physicochemical descriptors to the amino acid residues of the selected amino acid pseudo-sequence involved in one or more binding sites, (v) optionally, for each 7TM receptor mathematically manipulating the physicochemical descriptors of step (iv) to obtain a simplified measure of the physicochemical properties of the binding site. (vi) for each 7TM receptor generating a similarity score as defined herein by comparing the physicochemical descriptor or, if relevant, the simplified measure for the first 7TM receptor with the physicochemical descriptors or, if relevant, the simplified measures for the one or further 7TM receptors, (vii) optionally, ranking the 7TM receptors with respect to the physicochemical properties of their binding sites according to the similarity scores obtained in step vi)

### FIELD OF THE INVENTION

The present invention relates to comparisons of 7TM receptor proteins with respect to the physicochemical properties of amino acid residues in the binding site without information from ligands interacting with the receptor.

### BACKGROUND

7TM receptor proteins constitute the largest family of biological targets for current drugs. Drug development of ligands for these receptors has not been able to benefit from efficient structure-based drug design technologies due to the lack of detailed structural information. Determination of the exact structure of the binding site of transmembrane receptors is not generally amenable to X-ray crystallography or NMR as for soluble proteins, due to the inherent difficulties in producing large amounts of active membrane protein and in the case of X-ray crystallography producing crystals of these. Accordingly, the 3D structure of bovine rhodopsin is the only receptor that so far has been solved by X-ray crystallography at atomic resolution (Palczewski. K. et al, Science, (2000) 289, 739-745).

Despite the low sequence similarities, homology models of other 7TM receptors of the Class A type have been derived based on the bovine rhodopsin structure. Identification of binding sites and binding modes of ligands to 7TM receptors are supported by combining information from other experimental techniques; for example, site-directed mutagenesis, metal-ion site engineering, substituted cysteine accessibility method, site directed spin labelling and photoaffinity labelling. For references on designing drugs for 7TM receptors or G-protein coupled receptors (GPCRs), see: Drug design strategies for targeting G-protein coupled receptors. Klabunde,T.; Hessler, G. ChemBioChem (2002) 3, 928-944; G-Protein coupled receptors: Models, mutagenesis, and drug design. Bikker, J. A.; Trumpp-Kallmeyer, S.; Humblet, C. Journal of Medicinal Chemistry (1998) 41, 2911-2927; Modelling G-protein coupled receptors for drug design. Flower, D. R. Biocimica et Biophysica Acta (1999) 1422, 207-234; Locating ligand-binding sites in 7TM receptors by protein engineering, T. W. Schwartz. Curr. Opin. Biotechnol. (1994) 5, 434-444.

Calculated similarity scores to infer the overall “global” protein sequence homology are known (Needleman S. & Wunsch C. L. J. Mol. Biol. 48, 444-453 1970; Smith T. F. & Waterman M. J. Mol. Biol. (1981) 147, 195-95; Pearson W. R. & Lipman D. J. Proc. Natl. Acad. Sci. USA, (1988) 85, 2444-48; Altschul S. F. J. Mol. Biol. (1991) 219, 555-565; Altschul S. F. J. Mol. Evol. (1993) 36, 290-300). Traditional evolutionary phylogenetic analyses considering the protein “global” sequences are also known. Conventional sequence similarity scores and phylogenetic analysis of protein sequences are based upon statistics on how frequently different amino acids are evolutionary replaced with other amino acids as reported in substitution matrices such as the BLOSUM (derived form blocks of aligned sequences) and PARM (point accepted mutations) series (Henikoff S. & Henicoff J. G. Proc. NatL. Acad. Sci. USA, (1992) 89, 10915-919; Henikoff S. & Henicoff J. G. Proteins (1993) 17, 49-61; Dayhoff M. Schwartz R. M. & Orcutt B. C. Atlas of protein Sequence and Structure (1978) 5, 345-52) and they reflect how nature has happened to replace them during the evolutionary period.

As illustrated in the conventional phylogenetic analysis of the GPR44 (CRTH2) receptor (FIG. 1), the following relationships with a number of receptors are revealed according to reference J. Exp. Med. Volume (2001) 193, 255-261. Notably, the AT1 and AT2 receptors are not identified according to this evolutionary relationship model. We will later show how different the relationships of receptors to GPR44 with respect to the ligand-binding properties in the binding site are.

Such evolutionary-based similarity scores of sequences are different from similarity scores based on actual physicochemical properties associated with the individual amino acids. Only in the cases where phylogenetically very closely related proteins are compared, will the analyses yield a similar result.

Other means to compare mono-amine related 7TM receptors based on chemogenomics input have been devised (A novel chemogenomics knowledge-based ligand design strategy—Application to G-protein-coupled receptors, E. Jacoby. Quant. Struct.-Act. Relat. (2001) 20, 115-123).

Sequence similarity (as defined in various substitution matrices) versus chemical sequence similarity will usually not produce comparable similarity scores or identify the same related receptors. In this invention, selected amino acid residues defined as being part of the 7TM receptor binding site and constituting an amino acid pseudo-sequence are assigned physiochemical descriptors, which are compared and ranked according to a given receptor of interest.

There exists a need for a novel method for comparing 7TM receptors with respect to the physicochemical properties of their binding sites, without using information from a ligand. This is especially important when considering 7TM receptors for which no ligands are known e.g. orphan receptors.

### SUMMARY OF THE INVENTION

An understanding of the physicochemical properties of a binding site will assist in designing ligands that may bind to a receptor. The present invention describes methods for comparing and/or ranking 7TM receptors according to the physicochemical properties of their binding sites, allowing similarities and differences between said 7TM receptors to be identified.

In one embodiment, the method according to the present invention relates to a pseudo-sequence method for comparing a first 7TM receptor with one or more further 7TM receptors with respect to the physicochemical properties of their binding sites, the method comprising the steps of:
i) optionally, aligning part of or all of the amino acid sequence of the first 7TM receptor with part of or all of the amino acid sequence of the one or more further 7TM receptors,
ii) selecting, in a sequential or non-sequential order, at the most 12 amino acid residues per helix, and at the most 12 amino acid residues in one or more extracellular loops, which are involved in one or more binding sites of each 7TM receptor,
iii) forming a pseudo-sequence comprising at the most 50 amino acids from the selected sequential or non-sequential amino acid residues,
iv) for each 7TM receptor assigning one or more physicochemical descriptors to the amino acid residues of the selected amino acid pseudo-sequence involved in one or more binding sites,
v) optionally, for each 7TM receptor mathematically manipulating the physicochemical descriptors of step iv) to obtain a simplified measure of the physicochemical properties of the binding site,
vi) for each 7TM receptor generating a similarity score as defined herein by comparing the physicochemical descriptor or, if relevant, the simplified measure for the first 7TM receptor with the physicochemical descriptors or, if relevant, the simplified measures for the one or further 7TM receptors,
vii) optionally, ranking the 7TM receptors with respect to the physicochemical properties of their binding sites according to the similarity scores obtained in step vi).

In a second embodiment, the present invention describes a method for classifying 7TM receptors according to the physicochemical properties of their binding sites

The invention further relates to drug discovery methods for identifying ligands, which bind to a first 7TM receptor and bind or potentially bind to one or more further 7TM receptors. Additionally, methods are described for identifying a lead compound or a potential lead compound for a 7TM receptor. Furthermore, the present invention describes a drug discovery method for constructing a pharmacophore model for a 7TM receptor.

Importantly, the methods of the present invention can be carried out using only information from the 7TM receptor, i.e. without any information on a ligand or on ligand-receptor interactions.

### DETAILED DESCRIPTION OF THE INVENTION

The following abbreviations and definitions are used throughout the description.

A glossary of terms used in Medicinal Chemistry or Computational Drug Design is found in Annual Reports in Medicinal Chemistry, Volume 33, Division of Medicinal Chemistry of ACS, Academic Press, pages 385-409. For a discussion of the difference between “Leads” and “Drugs”, see T. I. Oprea et al, J. Chem. inf. Comput Sci., 2001, 41, 1308-1315. 7TM receptor, i.e. a 7-transmembranal (7TM) receptor having seven α-helices that span the cell membrane and are usually coupled to G-proteins. A list of specific 7TM receptors is given herein. The term is used interchangeably with “receptor”, and one skilled in the art will understand the meaning according to the context.

A “binding site” is a region of a biological molecule (e.g. a protein such as a 7TM receptor) to which a ligand may bind. A binding site comprises one or more amino acid residues arranged in a particular geometry so as to provide an environment with a specific arrangement of charged, polar or non-polar regions, which can interact with a ligand. The binding site could represent the region encompassing the entire ligand, or consist of the main ligand-binding site, or be a subsite engaged in interactions with a part of the ligand.

An “amino acid pseudo-sequence” is defined as selected amino acid residues in sequential or non-sequential order, involved in one of more ligand binding sites in 7TM receptors. In comparing pseudo-sequences for different 7TM receptors the positions in the pseudo-sequence correspond to the same generic numbers. E.g. a generic pseudo-sequence could be exemplified with amino acids positioned in I-04, I-15, I-20, II-02, II-07, II-21, III-06, III-13, . . . , VII-02, VII-09.

“Binding site modef”, i.e. a model achieved by computer-assisted molecular design (CAMD) that describes how a ligand binds to a 7TM receptor.

A “bitmap” is defined as a string of physicochemical descriptor values used to describe certain chemical features of amino acid residues of interest. A bitmap may be derived from all physicochemical descriptors of the amino acid residues of the binding site or from a simplified measure of the physicochemical descriptors. “Chemogenomics,” i.e. correlation of chemical features of known biologically active compounds (i.e. ligands) with various biological targets. Cf. “Methodologies used for analysis of common drug shapes” G. W. Bemis and M. A. Murcko, J. Med. Chem., 1996, 39, 2887-2893. “Computer-assisted drug design (CADD)”, i.e. computational techniques used to discover, design, and optimise small organic compounds that are biologically active compounds with a putative use as drugs.

“Design”, i.e. application of all techniques leading to the discovery of new chemical entities (e.g. ligands) with specific properties such as affinity for a given receptor.

“Library or chemical library”, i.e. collection of ligands that are often produced by parallel synthesis or represent a collection of historic or commercial compounds. Cf. B. A. Bunin et al, Ann. Rep. Med. Chem, 1999, 34, 267-286. “Ligand”, i.e. small organic compound that might display affinity for a biological target molecule such as a 7TM receptor. Throughout the specification the term ligand is sometimes used equivalently with the term small organic compound. A person skilled in the art will understand the meaning according to the context. “Main ligand-binding site”, refer to the binding site located between TM-III, IV, -V, -VI, and VII in 7TM receptors which corresponds to where, for example, the main part of retinal is found in the rhodopsin structure and to where ligands have been mapped to bind in a variety of 7TM receptors. Residues, which line this site, are those that are generally involved in ligand binding, and therefore those, which are preferred residues in alignments in the present invention. “Pharmacophore modef”, i.e. a model describing the combination of steric and electronic features of a ligand that are necessary for interaction with a specific 7TM receptor which may trigger or block its biological response. “Physicochemical descriptors” can be experimentally derived and/or theoretically calculated. The descriptors reflect 7TM receptor-ligand interaction features of the amino acid residues, i.e. they may reflect hydrophobic properties, electronic properties, steric properties or hydrogen bonding capabilities and other properties of importance for ligand-protein interactions. Some descriptors can be seen to reflect combinations of such properties, especially combinations of electronic and steric features. The descriptors also include dummy parameters or indicator variables, e.g. 1 and 0, to denote absence or presence of certain properties such as absence or presence of aromatic side chains, hydrophobic side chains, negatively charged side chains, positively charged side chains, polar side chains, hydrogen-bond donating side chains, hydrogen-bond accepting side chains or other selected features

“Receptor moder”, i.e. a 3-dimensional model of a biological target molecule such as a 7TM receptor based on information from structurally known analogous proteins (homology model) and complementary data such as structure-activity data of ligands or antibodies binding to the biological target molecule and mutational studies.

A “similarity score” is a mathematical indicator of the similarity between two (potential) binding sites. Expressions of similarity scores include the Tanimoto coefficient, the Tversky coefficient and the Euclidian distance measure. 7TM receptors having close similarity scores have a high degree of similarity of their (potential) binding sites.

A “small organic compound” is intended to indicate a small organic molecule of low molecular weight such as below 1000. The small organic compounds of specific interest in the present context are those that are capable of interacting with a membrane-associated protein such as a 7TM receptor, in such a way as to modify the biological activity thereof.

“Structure-based drug design”, i.e. using protein structural information from e.g. X-ray crystallography or NMR spectroscopy to assist in the design of therapeutic compounds—mostly of inhibitors which bind to enzymes. Cf. M. A. Murcko et al, Ann. Rep. Med. Chem, 1999, 34, 297-306.

In the method according to the present invention, the amino acid residues of a 7TM receptor are assigned physicochemical descriptors. It is then possible to compare different transmembrane proteins such as 7TM receptors with respect to the physicochemical properties of their binding sites. The process of comparing biological target proteins based on the physicochemical properties of their binding site will be referred to “physicogenomics” herein. The following steps are involved in physicogenomics:
Sequence search
Alignments
Analysis of binding site residues important for ligand binding and recognition
Comparison of physicochemical properties of binding site

In other words, the method according to the present invention relates to a method for comparing a first 7TM receptor with one or more further 7TM receptors with respect to the physicochemical properties of their binding sites, the method comprising the steps of:
i) optionally, aligning part of or all of the amino acid sequence of the first 7TM receptor with part of or all of the amino acid sequence of the one or more further 7TM receptors,
ii) selecting, in a sequential or non-sequential order, at the most 12 amino acid residues per helix, and at the most 12 amino acids in one or more extracellular loops, which are involved in one or more binding sites of each 7TM receptor,
iii) forming a pseudo-sequence comprising at the most 50 amino acid residues from the selected sequential or non-sequential amino acid residues,
iv) for each 7TM receptor assigning one or more physicochemical descriptors to the amino acid residues of the selected amino acid pseudo-sequence involved in one or more binding sites,
v) optionally, for each 7TM receptor mathematically manipulating the physicochemical descriptors of step iv) to obtain a simplified measure of the physicochemical properties of the binding site,
vi) for each 7TM receptor generating a similarity score as defined herein by comparing the physicochemical descriptor or, if relevant, the simplified measure for the first 7TM receptor with the physicochemical descriptors or, if relevant, the simplified measures for the one or further 7TM receptors,
vii) optionally, ranking the 7TM receptors with respect to the physicochemical properties of their binding sites according to the similarity scores obtained in step vi).

Importantly, this comparison or ranking can be carried out using only information from the 7TM receptor, i.e. without any information on a ligand. Therefore, the present invention also relates to a method as described herein, wherein the comparison is made without using data related to binding affinity of a ligand to a 7TM receptor.

The present invention may also be used to classify 7TM receptors according to the physicochemical properties of their binding sites. Hence, the present invention describes a method for classifying 7TM receptors according to the physicochemical properties of their binding sites. This classification may also be carried out using only information from the 7TM receptor, i.e. without any information on a ligand. Hence, the classification may be made without using data related to binding affinity of a ligand to a 7TM receptor.

Method for Obtaining Lead Structures for New 7TM Receptors

It is generally recognized that structurally related small organic molecules often bind the same biological target proteins. Cf. “Do Structurally Similar Molecules Have Similar Biological Activity?” Yvonne C. Martin, James L. Kofron, and Linda M. Traphagen, J. Med. Chem. (2002) 45, 4350-4358. Conversely, related biological targets often bind the same or similar small organic molecule ligands. Notably, there are exceptions from these general rules—otherwise development of receptor-selective ligands would have been an impossible task.

Having identified which 7TM receptors resemble each other with respect to the physiochemical environment in the binding site as described herein, it is possible to utilise known ligands which interact with one receptor as chemical starting points (so called chemical leads) for drug development on related receptors.

In other words, the present invention also relates to a drug discovery method for identifying ligands, which bind to a first 7TM receptor and potentially bind to one or more further 7TM receptors, the method comprising the steps of i) to vii) as defined above and the further steps of
viii) selecting from one to about 100 further 7TM receptors which have the closest similarity scores to the first 7TM receptor,
ix) identifying ligands which potentially bind to those further 7TM receptors selected in step viii) by selecting ligands that bind to the first 7TM receptor.

In addition, the method described above may be combined with a screening step, to determine ligands, which do bind to a 7TM receptor. Therefore, the present invention additionally relates to a drug discovery method for identifying ligands which bind to a first 7TM receptor and to one or more further 7TM receptors, the method comprising the steps of i) to vii) as defined above and the further steps of:
viii) selecting from one to about 100 further 7TM receptors which have the closest similarity scores to the first 7TM receptor,
ix) screening ligands that bind to the first 7TM receptor against the selected 7TM receptors of step viii).

The process of transfer of a chemical starting point from one protein target to another related protein target is often referred to as chemogenomics. Thus, an efficient physicogenomic method to compare 7TM receptors having known ligands (known or potential drug molecules) with novel receptors lacking identified ligands allows for possibilities to identify lead structures for drug development since no previous information regarding ligands binding to the new receptor under investigation is needed. Furthermore, comparison of 7TM receptors having ligands with orphan receptors lacking identified endogenous ligands allows for the identification of lead structures for drug development also on orphan receptors since no previous information regarding ligands binding to the receptor under investigation is needed. Consequently, known ligands of closely related receptors could serve as good chemical starting points to identify lead structures against a receptor for which no agonist or antagonist are known.

In a further aspect, the present invention relates to a drug discovery method for identifying a potential lead compound for a first 7TM receptor, the method comprising the steps of i) to vii) as defined above and the further steps of
viii) selecting from one to about 100 further 7TM receptors which have the closest similarity scores to the first 7TM receptor,
ix) identifying ligands that bind to said one or more further 7TM receptors to construct a library including a potential lead compound for the first 7TM receptor.

The method for identifying a potential lead compound may additionally be linked to a screening step, so that libraries containing potential lead compounds may be narrowed down to give lead compounds. Hence, the present invention further relates to a drug discovery method for identifying a lead compound for a first 7TM receptor, the method comprising the steps of i) to vii) as defined in herein and the further steps of
viii) selecting from one to about 100 further 7TM receptors which have the closest similarity scores to the first 7TM receptor,
ix) identifying ligands that bind to said one or more further 7TM receptors to construct a library, and
x) screening said library against the first 7TM receptor to identify a lead compound for the first 7TM receptor.
   Pharmacophore Model

Having established physicogenomic relationships between 7TM receptors one can also derive pharmacophore models based on ligands, which are known, to bind to 7TM receptors related to the receptor under investigation. This allows for a more cost-effective process of retrieving and screening a limited number of compounds than under a conventional high-throughput screening (HTS) campaign usually conducted in larger pharmaceutical industries when looking for lead structures for a novel biological target.

Furthermore, a pharmacophore model that can be used for in silico screening or design of focused chemical libraries could be derived from analogously identified structures.

Hence, the present invention relates to a drug discovery method for constructing a pharmacophore model for a first 7TM receptor, the method comprising the steps of i) to
vii) as defined in herein and the further steps of
viii) selecting from one to about 100 further 7TM receptors which have the closest similarity scores to the first 7TM receptor,
ix) identifying ligands that bind to said one or more further 7TM receptors to construct a pharmacophore model.

In one embodiment of the present invention the first 7TM receptor is one for which no ligands have been identified. Additionally, the first 7TM receptor may be an orphan receptor. 7TM receptors, which have similarity scores closest to each other, have most similar physicochemical properties of their binding sites. Therefore, when selecting 7TM receptors based on their similarity score, with the aim of choosing those with similar physicochemical properties of their binding sites, it is important to select those with the closest similarity scores. The number of further 7TM receptors which are selected in step vii) (above) may be from one to 50, from one to 25 or from one to 15.

Having defined the relevant binding site and assigned the proper physicochemical descriptors to selected amino acid residues involved in the binding site, the 7TM receptors are compared to each other by a suitable computerised mathematical model, which is capable of comparing a large number of receptors by an effective algorithm. Preferably, all identified 7TM receptors should be aligned and compared based on the physicochemical descriptors of pseudo-sequences derived from selected amino acid residues involved in the binding site. Accordingly, the present invention relates to any of the methods as described herein, wherein the method is executed by a computer under the control of a program and the computer includes a memory for storing said program.

Generic Numbering System for 7TM Receptors

The 7TM receptor superfamily is composed of many hundreds of receptors that may be further divided into smaller sub-families of receptors. The largest of these sub-families of 7TM receptors is composed of the rhodopsin-like receptors (also termed the family A receptors), which are named after the light-sensing molecule from our eye. The receptors are integral membrane proteins characterized by seven transmembrane (7TM) segments traversing the membrane in an antiparallel way, with the N-terminal on the extracellular side of the membrane and the C-terminal on the intracellular side. Within the membrane- embedded part and in some cases in the membrane proximal parts embedded in the aqueous environment surrounding the cell membrane, the polypeptide adopts a helical secondary structure. The lengths, and the beginning, centre and ends relative to the lipid brayer membrane of these helices may be deduced from solved three-dimensional structures of the receptor proteins (Palczewski K. et al., Science, (2000) 289 (5480), 739-45). However, since the three-dimensional structure of only a single receptor has been solved to date, the helical lengths, and the beginning, centre and ends relative to the lipid bilayer membrane of each of the seven helices may be dissected by sequence analysis (J. M. Baldwin, EMBO J. (1993) 12(4), 1693-703; J. M. Baldwin et al., J. Mol Biol, (1997) 272(1), 144-64).

A useful tool in the analysis of 7TM receptors is the generic numbering system for residues of 7TM receptors. Within the many hundred members of the rhodopsin-like receptor family, a number of residues especially within each of the transmembrane 5 segments are highly, but not totally, conserved—termed key residues. These residues may be used to direct an alignment of the primary protein sequences within the transmembrane segments together with other standard principles and techniques, well known to persons skilled in the art (for example hydrophobicity plots). Additionally a number of other residues occur within the transmembrane segments that are highly conserved, and these may be used to further direct an alignment of the transmembrane segments. These are particularly useful when a given key residue in a transmembrane segment has been substituted through evolution by another amino acid of a dissimilar physiochemical nature.

However, due to differences in the length of especially the N-terminal segment, the third intracellular loop 3 and the C-terminal segment, residues located at presumably structurally corresponding positions in different 7TM receptors are numbered differently in different receptors. However, based on the conserved key residues in each transmembrane segment, a generic numbering system has been suggested (J M Baldwin, EMBO J. (1993)12(4), 1693-1703; T W Schwartz, Curr. Opin. Biotech. (1994) 5, 434-444). On the basis of the key residues present in the receptor family, the transmembrane segments are generically numbered. For example, in TM-II the highly conserved acidic function, aspartate (Asp) in the rhodopsin-like family is given the generic number 10, i.e. AspII:10, on the basis of its position in the helix. All other residues in the helix are hence numbered on this basis. In FIG. 2.1 a schematic depiction of the secondary structure of a rhodopsin-like 7TM receptor is shown with one or two conserved, key residues highlighted in each transmembrane segment:
AsnI:18; AspII:10; CysIII:01 and ArgIII:26; TrpIV:10; ProV:16; ProVI:15; ProVII:17.

In relation to the present invention, it is important that residues involved in, for example, ligand binding can be described in this generic numbering system. For example, in the β2-adrenergic receptor the main anchor point for the catecholamine agonists is a highly conserved aspartate 113 residue in TM-III (AspIII:08). Interestingly, the aspartate is located one helical turn deeper in the receptor structure to the counter-ion (GluIII:04) of the Schiff base in rhodopsin. Two serine residues at positions 204 and 207 in TM-V (SerV:09 and SerV:12) were identified as contact points for the hydroxy-functionality of the catechol ring and were suggested also to be part of the control of the transition between the inactive and active state of the receptor. Moreover phenylalanine 290 and asparagine 293 on TM-VI (PheVI:17 and AsnVI:20 respectively) were identified as interacting with the catechol ring and the β-hydroxy of the agonists respectively. In catecholamine and 5-hydroxytryptamine receptors, residue VII:06 has been consistently identified as an interaction point for partial agonists and antagonists. Interestingly, a β2-selective non-catechol agonist TA-2005 was suggested to interact with tyrosine 308 on TM-VII (TyrVII:02), located one helical turn above VII:06, and was unaffected with respect to receptor activation by mutation of either serine residues 204 or 207 suggesting that different agonist activation modes may exist even within a particular receptor. Hence the agonist-binding site in the β2-adrenergic receptor is located between the transmembrane segments at a general position rather similar to the retinal binding site in opsin. Comparing the binding site of the β2-adrenergic receptor described above using the generic nomenclature to, for example, the dopamine D2-receptor, quickly identifies residues Asp114 in TM-III (AspIII:08), Ser194 and Ser197 in TM-V (SerV:09 and SerV:12), Phe390 and His393 (PheVI:17 and HisVI:20) hence suggesting that certain key residues in the binding of the catecholamines to the β2-adrenergic receptor are conserved to for example the dopamine receptor. Similarly the described binding site—or other residues suspected to be important in defining for example a binding site of a ligand—can easily be compared to even several and very distantly related receptors at the same time, where little or no conservation of the particular binding site of the endogenous catecholamine binding site exist, but where the corresponding residues nevertheless may be important for binding, for example, artificial non-peptide antagonists.

It is only in the rhodopsin-like receptor family that a generic numbering system has been established; however, it should be noted that although the sequence identity between the different families of 7TM receptors is very low, it is believed that they may share a more-or-less common seven helical bundle structure. Hence an analogous system may be developed for the other families of 7TM receptors, for example the family B class of receptors, composed of, among others, the glucagon receptor, the glucagon-like peptide (GLP) receptor-1, the corticotropin releasing factor (CRF) receptor-1, vasoactive intestinal peptide (VIP) receptor, pituitary adenylate cyclase-activating polypeptide (PACAP) receptor etc. (J. W. Tams et al., Receptors Channels (1998) 5(2), 79-90). Again, on the basis of the key residues present in the family B class of receptors, the transmembrane segments are generically numbered (FIG. 2.2). For example, in TM-I, the highly conserved hydroxy function, serine (Ser) is given the generic number 8, i.e. SerI:08 on the basis of its approximate position in the helix; in TM-II the highly conserved histidine (His) is given the generic number 6 i.e. HisII:06; in TM-III the highly conserved cysteine (Cys) is given the generic number 1 i.e. CysIII:01; in TM-IV the highly conserved proline (Pro) is given the generic number 13 i.e. ProIV:13; in TM-V the highly conserved asparagine (Asn) is given the generic number 14 i.e. AsnV:14; in TM-VI the highly conserved leucine (Leu) is given the generic number 9 i.e. LeuVI:09; in TM-VII the highly conserved glycine (Gly) is given the generic number 13 i.e. GlyVII:13. All other residues in the helices are hence numbered on this basis. Thus, all the techniques described in the present invention can be applied to the other families of 7TM receptors with minor modifications. This generic numbering system together with general knowledge of the 3D structure of the 7TM receptors and knowledge from systematic ligand binding site analysis makes it possible to predict or identify contact points for ligands based on the DNA sequence coding for the 7TM receptor (see FIG. 2.1 and 2.2).

7TM receptors of interest in the present invention comprising 7 transmembrane domains include but are not restricted to G-protein coupled receptors, such as receptors for: acetylcholine, adenosine, norepinephrin and epinephrine, amylin, adrenomedullin, anaphylatoxin chemotactic factor, angiotensin, apelin, bombesin (neuromedin), bradykinin, calcitonin, calcitonin gene related peptide, conopressin, corticotropin releasing factor, , calcium, cannabinoid, CC-chemolines, CXC-chemokines, CX3C-chemokinees, cholecystokinin, corticotropin-releasing factor, dopamine, elcosanoids, endothelin, fMLP, GABAB, galanin, gastrin, gastric inhibitory peptide, glucagon, glucagon-like peptide I and 11, glutamate, glycoprotein hormone (e.g. FSH, LSH, TSH, LH), gonadotropin releasing hormone, growth hormone releasing hormone, growth hormone releasing peptide, Ghrelin, histamine, 5-hydroxytryptamine, leukotriene, lysophospholipid, melanocortins, melanin concentrating hormone, melatonin, motilin, neuropeptide Y, neurotensin, nocioceptin, odor components, opiods, retinal, orexins, oxytocin, parathyroid hormone/parathyroid hormone-related peptides, pheromones, platelet-activating factor, prostanoids, secretin, somatostatins, tachykinins, thrombin and other proteases acting through 7TM receptor, thyrotropin-releasing hormone, pituitary adenylate activating peptide, vasopressin, vasoactive intestinal peptide and virally encoded receptors; and 7TM receptors coded for in the human genome and for which an endogenous receptor-ligand has or has not yet been assigned; in particular: adenosin, galanin, CC-chemokines, CXC-chemokines, melanocortin, bombesin, cannabinoid, lysophospholipid, fMLP, neuropeptide Y, tachykinin, dopamine, histamine, 5-hydroxytryptamine, histamine, mas-proto-oncogene, melanin concentrating hormone receptor, Glucose-dependent insulinotropic polypeptide, Glucagon-like peptide-1 receptor, glucagon receptor, acetylcholine, oxytocin, human herpes virus encoded receptors, Epstein Barr virus induced receptors, cytomegalovirus encoded receptors and bradykinin receptors; and 7TM proteins coded for in the human genome but for which no endogenous receptor-ligand has yet been assigned; preferably the galanin receptor type 1, leukotriene B4 receptor, CCR1, CCR2, CCR3, CCR4, CCR5, CCR6, CCR7, CCR8, CCR9, CCR10, CXCR1, CXCR2, CXCR3, CXCR4, CXCR5, CXCR6, CX3CR1, melanocortin-1 receptor, melanocortin-3 receptor, melanocortin-4 receptor, melanocortin-5 receptor, MCH-1, MCH-2, GIP receptor, GLP-1 receptor, bombesin receptor subtype 3, cannabinoid receptor 1, cannabinoid receptor 2, EDG-2, EDG-4, FMLP-related receptor I, FMLP-related receptor 11, NPY Y6 receptor, NPY Y5 receptor, NPY Y4 receptor, NK-1 receptor, NK-3 receptor, D1 receptor, D2 receptor (short), D2 receptor (long), D3 receptor, D4 receptor, D5 receptor, D6 receptor, D7 receptor, D7 receptor, D8 receptor, duffy antigen; US27, US28, UL33 and U78 from human cytomegalovirus; U12 and U51 from human herpes virus 6 or 7, ORF74 from human herpes virus 8, and histamine H1 receptor, MAS proto-oncogene, muscarinic M1 receptor, muscarinic M2 receptor, muscarinic M3 receptor, muscarinic M5 receptor, oxytocin receptor, XCR1 receptor, EBI2 receptor, RDC1 receptor, GPR12 receptor or GPR3 receptor, and 7TM receptors coded for in the human genome and for which an endogenous receptor-ligand has or has not yet been assigned. These 7TM receptors may be studied in a monomeric or in a dimeric form, which may be either homo-dimeric or heterodimeric.

Aligning 7TM Receptor Proteins

As appears from the above, it is important to align at least a part of the amino acid sequences of the receptors to be compared. In some cases this information may already be available and, therefore, such an alignment step may be omitted, but in other cases the method of the invention includes a step of alignment.

Firstly, sequence databases, such as SWISSPROT, SPTREMBL, EMBL, PIR etc. are searched for human GPCR sequences using the Sequence Retrieval System (network browser for databanks in molecular biology) SRS. The identified sequences are then aligned using conventional alignments algorithms such as ClustalW (Thompson J. D. Higgins D. G. & Gibson T. J. Nucleic Acids Research. (1994) 22, 4673-80) The resulting alignment is manually inspected and refined if necessary, so that conserved generic sequence signatures within the seven transmembrane 7TM helices are satisfied (Palczewski. K. et al, Science, (2000) 289, 739-745).

Secondly, the helices of the 7TM receptor are identified based on hydrophobicity plots, the conserved residues within the sub-family of receptors and—for family A receptors—the sequence alignment to the recent published crystal structure of rhodopsin (OPSD).

Furthermore, the invention relates to methods as described herein, wherein step i) is included and the alignment is based on a model developed for 7TM receptors. The 7TM receptors of the present invention may be Class A, Class B, Class C or taste receptors

In one embodiment, the invention describes a method or methods described above, wherein step i) is included and the alignment is made with respect to transmembrane positioning of α-helices of 7TM receptors.

A method according to the invention involves the use of a pseudo-sequence. A pseudo-sequence is obtained from at the most 12 amino acid residues per 7TM helix, and at the most 12 amino acids in one or more extracellular loops, sequential or non-sequential, involved in one of more binding site. Furthermore, such a pseudo-sequence may comprise at the most 50 amino acid residues. In a specific embodiment at the most 8 such as, e.g., at the most 6 amino acid residues per 7TM helix or extracellular loop form the pseudo-sequence containing at the most 40 amino acid residues such as, e.g., at the most 30 amino acid redidues. In an embodiment of the invention only amino acid residues from at the most 6 such as, e.g., 5 helices are included in the pseudo-sequence.

A surprinsingly good reflection of the physicochemical environment in the binding site is conveyed by the relatively few amino acids invoked in the analysis of only a relatively short pseudo-sequence. This is supported by the fact that ligands binding to receptors that have been found to be related to the given receptor also could display affinity for the given receptor (cf. investigation of CRTH2 and identification of the related receptor angiotensin II and hence a angiotensin II ligand candesartan also binding to CRTH2).

A selection of relevant amino acid residues for the pseudo-sequence can be made by a person skilled in the art based on current knowledge on 7TM receptors as discussed in the paragraph “Generic numbering system for 7TM receptors”. Examples of relevant literature are T. Klabunde, G. Hessler, Drug design strategies for targeting G-protein-coupled receptors. Chembiochem. 3 (2002) 928-44; D. R. Flower, Modelling G-protein-coupled receptors for drug design, Biochimica et Biophysica Acta 1422 (1999) 207-234; J. A. Bikker, S. Trumpp-Kallmeyer, and C. Humblet G-Protein Coupled Receptors: Models, Mutagenesis, and Drug Design Journal of Medicinal Chemistry 41 (1998) 2911-2927.

Although amino acid residues known to be important for small molecule ligand interactions of course are of interest in construction of the pseudo-sequence, the present invention is not limited thereto.

An example of such an alignment for a random set of selected 7TM receptor human sequences is shown in the table below. For this illustration, the sequences and identification codes for the 7TM receptors are retrieved from www.pcr.org. The amino acid residues, in sequential or non-sequential order, are selected from different helices located in the binding site. For GPR44, the following amino acid residues, up to six per helix, from TM-III, TM-IV, TM-V, TM-VI and TM-VIII. have been selected. In an specific example given below, the selected residues for TM-VII correspond to VI-02 (Leu), VII-06 (Thr) and VII-09 (Ala) in the generic numbering. The rest are assigned analogously as described above.

TM Helix: III IV V VI VII
GP44_HUMAN HSFFMF NTY AKFA WYHSEA LTA

The amino acid residues, e.g. up to six per helix, in sequential or non-sequential order, are selected from III-04 to VII-09 to form the following 22 amino acid pseudo-sequences, which are used in the alignment and subsequent comparison.

TABLE

Pseudo-sequence generic numbering alignment
of selected human 7TM receptors.

| | |
|---|---|
| GP44_HUMAN | HSFFMFNTYAKFAWYHSEALTA |
| O2T1_HUMAN | QHYLVGDGLSINFLFSLYAKVT |
| O7C2_HUMAN | QIFIGCGSETEIFVLCLYSLVT |
| B3AR_HUMAN | WTDVVTVSPVSSSWFFNRAFNG |
| PE24_HUMAN | STLLSLTTTAASSSLVVNQDIA |
| APJ_HUMAN | SSIFMYLAVGSTGWYHKYMFTS |
| O1E1_HUMAN | QMFLGDHAHACFDVFLLYATMT |
| FML2_HUMAN | VHIDLFLTNLHFGWYEGMAISA |
| ACTR_HUMAN | IDFVLLTGMVVITWFVVMTFGI |
| 5H4_HUMAN | RTDVTTISPACSAWFFNDPWLG |
| NFF2_HUMAN | SGQGVAIMSTVYRWLWMSDYHA |
| O2B2_HUMAN | QLFLGSNSQHVDFLVTLYAKLG |
| AG2R_HUMAN | ASVSLYASAGKNGWHQTDVMIA |
| O5U1_HUMAN | QVFIASSGHKIHFRSARVFLVT |
| 1019_HUM | NLLSRTLNLHLYEFSIGSMFLT |
| C3X1_HUMAN | TTFFFFVAQNTNGWYNIETLEA |
| 5H6_HUMAN | WTDVCSASPVASTWFFNQAFTG |
| BRB2_HUMAN | VNISLYLSMNLNGWFQTDTTSA |
| O2F2_HUMAN | QLSLGGNSQPTNIMFCLYIKVA |
| NMBR_HUMAN | IPQLVGLAESIFYWNHYRSTRS |
| OXI2_HUMAN | QMIHSMARISLSYYMISHRVNL |
| NTR2_HUMAN | YYHEAYLAMINVSWYHRYCYNF |
| AG2S_HUMAN | ASVSLYASAGKNGWHQTDVMIA |
| 5H2A_HUMAN | WIDVSTISIVGSSWFFNAVLVG |
| GP72_HUMAN | SRQYLHFSHDTFLWLNVLSYHA |
| ACM1_HUMAN | WLDYSNLWATTAAWYNVSTWYC |
| CKRA_HUMAN | ISYSFHLAAAQVGQYSLDTLSA |
| TA2R_HUMAN | MGMIGLLGPSLSLWLLITVLLA |
| OYD1_HUMAN | QMVHYARRYGVAAYAFFHRINV |
| LGR5_HUMAN | IGSISEKYSLLNCNVASSLKLV |
| O5V1_HUMAN | QLFVVGNSHNINFWFLVYIRVS |
| FSHR_HUMAN | AGTVSEAAPVCLDMISAASKVH |
| DADR_HUMAN | WVDISTISPASSSWFFNLPFVG |
| GRPR_HUMAN | IPQLVGLAESSFFWNHYRSSRA |
| AG22_HUMAN | FGLTMFSSTAKNGWFHTDALIG |
| O2D2_HUMAN | RLFLGCVSDSIAFLVFLYGKVA |
| O4F3_HUMAN | QIIHGGHSQPLDYFPMYPHKIA |
| O2H3_HUMAN | QIFLGTAWGQSTLVLSLYGKLA |
| HH1R_HUMAN | WLDYSTWVIKTANWYFFIAHIG |
| CML1_HUMAN | SNLIMFLSSTRFGWYHNELLTA |
| EBI2_HUMAN | TAFYTYQTLLACGFYHIHMLVM |
| O2G1_HUMAN | QMALGGSAYAIRLHSNRALNVT |
| ETBR_HUMAN | VPQKVGLAEDLFYWLHRKLDIA |
| GPR1_HUMAN | VFTVLDIGATKFGWYHSELITA |
| FML1_HUMAN | IHVDLFLTVGRFGWFQAGTVSA |
| NK4R_HUMAN | QNPIVFLAQHVIVWYHFTAYFA |
| GPR81_HUMA | GLLARAGTLHMFEYSVRFLLLT |
| GPR6_HUMAN | TVLVFALGPLRASWFACGSTLA |

Selection of Binding Site Amino Acid Residues

The alignment of a pseudo-sequence mentioned above is used to identify binding sites or potential binding sites of the 7TM receptor. Such identification is necessary in order to enable designation of physicochemical descriptors to the amino acid residues involved in the (potential) binding site.

As outlined above, certain amino acids have been identified to be frequently involved in ligand interactions. Thus, amino acid residues facing the core of the 7TM bundle and the general 7TM ligand binding site defined by the transmembrane helices in addition to residue positions in the extracellular loops determined experimentally to be important for ligand binding are selected. Therefore, in an embodiment of the invention, the binding site includes amino acid residues located in one or more extracellular loops of the 7TM receptors. In a further embodiment of the invention, the binding site includes amino acid residues located in one or more subsites of the binding site and in one or more extracellular loops of the 7TM receptors.

Relevant examples on identification of residue positions of importance for ligand binding and recognition can be found in: Y Yamano, K. Ohyama, S. Chaki, D. F. Guo, T. Inagami, Biochem. Biophys. Res. Commun. 187 (1992) 1426-1431; S. A. Hjorth, H. T. Schambye, W. J. Greenlee, T. W. Schwartz, J. BioL Chem. 269 (1994) 30953-30959; Y. H. Feng, K. Noda, Y. Saad, X. P. Liu, A. Husain, S. S. Karnik, J. Biol. Chem. 270 (1995) 12846-12850; K. Noda, Y. Saad, S. S. Karnik, J. Biol. Chem. 270 (1995) 28511-28514; H. Ji, M. Leung, Y. Zhang, K. J. Catt, K. Sandberg, J. Biol. Chem. 269 (1994) 16533-16536; Y. Yamano, K. Ohyama, M. Kikyo, T. Sano, Y. Nakagomi, Y. Inoue, N. Nakamura, I. Morishima, D. F. Guo, T. Hamakubo et al. J. Biol. Chem. 270 (1995) 14024-14030; K. Noda, Y. Saad, A. Kinoshita, T. P. Boyle, R. M. Graham, A. Husain, S. S. Karnik, J. Biol. Chem. 270 (1995) 2284-2289; H. T. Schambye, S. A. Hjorth, J. Weinstock, T. W. Schwartz, Mol. Pharmacol. 47 (1995) 425-431); V. Nirula, W. Zheng, R. Sothinathan, K. Sandberg, Br. J. Pharmacol. 119 (1996) 1505-1507.

Physicochemical Descriptors

Various physiochemical descriptors have previously been employed to classify and describe chemical features of peptides. In a method according to the present invention physicochemical descriptors are applied to amino acid residues located in or in the vicinity of the (potential) binding site. Use of such descriptors enables calculation of a similarity score between 7TM receptors so that a comparison of the individual 7TM receptors can easily be made.

Thus, structure-activity studies on peptides have shown the relevance of various physicochemical descriptors assigned to individual amino acid residues in describing biological properties by Quantitative Structure-Activity Relationships (QSAR), Principle Component Regression (PCR) and Partial Least-Squares (PLS) analysis. Such studies using various descriptors can be found in (among others): Simple parameterization of non-proteinogenic amino acids for QSAR of antibacterial peptides. Lejon, Tore; Svendsen, John S.; Haug, Bengt E. Joumal of Peptide Science (2002) 8, 302-306; Theory and applications of the integrated molecular transform and the normalized molecular moment structure descriptors: QSAR and QSPR paradigms. Molnar, Stephen P.; King, James W. International Journal of Quantum Chemistry (2001) 85, 662-675; Modelling of the Amino Acid Side Chain Effects on Peptide Conformation. Sak, Katrin; Karelson, Mati; Jarv, Jaak. Bioorganic Chemistry (1999) 27, 434442; The application of the intermolecular force model to peptide and protein QSAR. Charton, Marvin. Advances in Quantitative Structure-Property Relationships (1999) 2, 177-252; MS-WHIM Scores for Amino Acids: A New 3D-Description for Peptide QSAR and QSPR Studies. Zaliani, A.; Gancia, E., Journal of Chemical Information and Computer Sciences (1999) 39, 525-533.; A validation study of molecular descriptors for the rational design of peptide libraries. Matter, H. Journal of Peptide Research (1998) 52, 305-314; 3D-QSAR of angiotensin-converting enzyme inhibitors: functional group interaction energy descriptors for quantitative structure-activity relationships study of ACE inhibitors. Kim, Sanguk; Chi, Myung Whan; Yoon, Chang No; Sung, Ha-Chin. Journal of Biochemistry and Molecular Biology (1998) 31, 459-467; Descriptors for amino acids using MolSurf parametrization. Norinder, Ulf; Svensson, Peter. Journal of Computational Chemistry (1998) 19, 51-59; Amino Acid Side Chain Descriptors for Quantitative Structure-Activity Relationship Studies of Peptide Analogs. Collantes, Elizabeth R.; Dunn, William J., III. Journal of Medicinal Chemistry (1995) 38, 2705-13; Theoretical amino acid descriptors. Application to bradykinin potentiating peptides. Norinder, UIf. Peptides (New York, US) (1991)12, 1223-7; Dedicated principal properties for peptide QSARS: theory and applications. Skagerberg, Bert; Sjöström, Michael; Wold, Svante. Journal of Chemometrics (1990) 4, 241-53; Multivariate Parametrization of 55 Coded and Non-Coded Amino Acids. Jonsson, J.; Eriksson, L.; Hellberg, S.; Sjöström, M.; Wold, S. Quant. Struct-Act. Relat. (1989) 8, 204-209; Amino Acid Side Chain Parameters for Correlation Studies in biology and pharmacology. Fauchère, J. -L.; Charton, M.; Kier, L. B.; Verlooop, A.; Pliska, V. Int. J. Pept. Protein Res. (1988) 32, 269-278; Peptide Quantitative Structure-Activity Relationships, a Multivariate Approach. Hellberg, Sven; Sjöström, Michael; Skagerberg, Bert; Wold, Svante. Journal of Medicinal Chemistry (1987) 30, 1126-1135; Statistical Analysis of the Physical Properties of the 20 Naturally Occurring Amino Acids, Kidera, A.; Konishi, Y.; Oka, M.; Ooi, T.; Scheraga, J. A. J. Protein Chem. (1985) 4, 23-55; Relations between Chemical Structure and Biological Activity in Peptides. Sneath, P. H. A. J. Theor. Biol.(1966) 12,157-195.

Such physicochemical descriptors applied to amino acids in peptides reflect the forces involved in ligand-receptor interactions and, accordingly, will reflect the interacting properties of the amino acid side chains in proteins, especially transmembrane receptors such as 7TM receptors.

For example, the amino acids may be described by surface volumes and log P of side-chains (Norinder, Ulf; Svensson, Peter. Journal of Computational Chemistry (1998) 19, 51-59), ξ-angles and conformational strain energies ΔHₛₜᵣₐᵢₙ (Sak, Katrin; Karelson, Mati; Jarv, Jaak. Bioorganic Chemistry (1999) 27, 434-442) or principle properties z (Hellberg, Sven; Sjöström, Michael; Skagerberg, Bert; Wold, Svante. Journal of Medicinal Chemistry (1987) 30, 1126-1135) as shown in the table below.

| | | Surface | logP | angle | dH | | | |
|---|---|---|---|---|---|---|---|---|
| | | side chain | side chain | chi | strain | Z1 | Z2 | Z3 |
| Ala | A | 37.988 | −0.093 | −77.85 | 0.00 | 0.07 | -1.73 | 0.09 |
| Arg | R | 135.583 | 1.333 | 108.86 | 10.28 | 2.88 | 2.52 | −3.44 |
| Asn | N | 72.969 | −0.753 | −55.42 | 6.17 | 3.22 | 1.45 | 0.84 |
| Asp | D | 68.631 | −0.220 | 47.89 | 3.37 | 3.64 | 1.13 | 2.36 |
| Cys | C | 65.063 | 0.477 | 160.13 | 0.02 | 0.71 | −0.97 | 4.13 |
| Gln | Q | 95.356 | −0.344 | 134.68 | 1.42 | 2.18 | 0.53 | −1.14 |
| Glu | E | 87.730 | 0.384 | 53.27 | 2.37 | 3.08 | 0.39 | −0.07 |
| Gly | G | 7.206 | −0.616 | −148.03 | n.d. | 2.23 | −5.36 | 0.30 |
| His | H | 100.603 | 0.249 | 24.57 | 3.38 | 2.41 | 1.74 | 1.11 |
| Ile | I | 98.084 | 1.529 | −104.89 | 0.05 | −4.44 | −1.68 | −1.03 |
| Leu | L | 102.422 | 1.678 | −148.53 | 2.48 | −4.19 | −1.03 | −0.98 |
| Lys | K | 116.134 | 1.092 | 47.61 | 2.78 | 2.84 | 1.41 | −3.14 |
| Met | M | 107.039 | 1.581 | 6.37 | 2.79 | −2.49 | −0.27 | −0.41 |
| Phe | F | 121.451 | 2.021 | 47.67 | 3.59 | −4.92 | 1.30 | 0.45 |
| Pro | P | 77.446 | 1.005 | 169.73 | 10.49 | −1.22 | 0.88 | 2.23 |
| Ser | S | 44.705 | −0.733 | 30.24 | 0.73 | 1.96 | −1.63 | 0.57 |
| Thr | T | 67.162 | −0.043 | 46.04 | 3.71 | 0.92 | −2.09 | −1.40 |
| Trp | W | 153.493 | 2.379 | 178.69 | 0.08 | −4.75 | 3.65 | 0.85 |
| Tyr | Y | 128.937 | 1.547 | 49.11 | 3.50 | −1.39 | 2.32 | 0.01 |
| Val | V | 79.965 | 1.117 | −106.54 | 6.54 | −2.69 | −2.53 | −1.29 |

Ligands interact with biological target proteins via various forces such as ionic interactions, ion-dipole interactions, dipole-dipole interactions, hydrogen bond interactions, hydrophobic interactions, π-stacking interactions, edge-on aromatic interactions, cation-π interactions, dispersion and induction forces. Accordingly, physicochemical descriptors reflecting these interaction forces have successfully been employed in descriptors used in Quantitative Structure-Activity Relationships (QSAR), Principle Component Regression (PCR) and Partial Least-Squares (PLS) analysis of drug/ligand responses. “Quantitative structure-activity relationships and experimental design”, U. Norinder and T. Högberg, “Textbook of drug design and discovery”, Taylor and Francis, London, (2002), ppl 17-155.

The physicochemical descriptors can be experimentally derived and/or theoretically calculated. The descriptors can be seen to reflect hydrophobic properties, electronic properties, steric properties or hydrogen bonding capabilities. Some descriptors can be seen to reflect combinations of such properties, especially combinations of electronic and steric features. The present invention describes a method or methods wherein the physicochemical descriptors reflect 7TM receptor-ligand interaction features of the amino acid residues. Additionally, the physicochemical descriptors are chosen to reflect hydrophobic, electronic, steric, hydrogen bonding or other properties of the amino acid residues. Yet further, the physicochemical descriptors may reflect 3-dimensional features of the amino acid residues.

The physicochemical descriptors of the present method may be selected from descriptors used in quantitative structure-activity relationships (QSAR), Principle Component Regression (PCR) and Partial Least-Squares (PLS) analysis of peptides.

Typical hydrophobic descriptors are e.g. Partition coefficient (logP), Calculated partition coefficient (clog P, Prolog P, Maclog P), Distribution coefficient (log D), Polar surface area, Nonpolar surface area, TLC retention time, HPLC retention time, and HPLC capacity factor (log k).

Typical steric parameters are e.g. Molecular weight (MW), van der Waals volume, van der Waals radius, Molar refractivity (MR), STERIMOL parameters (L, B₁, B₅), Total surface area, occupied volume by a residue buried in globular protein, and bulkiness defined as the ratio of the side-chain volume to its length.

Typical electronic parameters are e.g. lonisation constant (pK_{COOH}, pK_{NH2}), Isoelectric point, Net charge at pH 7, ¹H NMR chemical shift, ¹³C NMR chemical shift, Calculated interaction energies, Electronic Charge Index (ECI), Charge transfer for carbons (CT), Maximum electrostatic potential (Vₘₐₓ), Minimum electrostatic potential (Vₘᵢₙ), Maximum local ionization energy (Iₘₐₓ) Minimum local ionization energy (Iₘᵢₙ), Molecular Electrostatic Potential (MEP) on Connolly Molecular Surface, Energy of highest occupied molecular orbital (E_{HOMO}), Energy of lowest unoccupied molecular orbital (E_{LUMO}), Dipole moment (μ), Polarizability (α), Most positive partial charge on a hydrogen atom (qH+), Most negative partial charge in the molecule (q−), and Partial charges on the oxygen and carbon atoms (qC, qO) of the carbonyl group.

Thus, the physicochemical descriptors may be selected from molecular weight (MW), van der Waals volume, van der Waals radius, molar refractivity (MR), STERIMOL parameters (L, B₁, B₅), Parachor (Pᵣ), polar surface area, non-polar surface area, total surface area, ionisation constant (pK_{COOH}, pK_{NH2}), isoelectric point, net charge at pH 7, partition coefficient (log P), calculated partition coefficient (clog P, Prolog P, Maclog P), distribution coefficient (log D), TLC retention time, HPLC retention time, HPLC capacity factor log k, ¹H NMR chemical shift, ¹³C NMR chemical shift, steric and electrostatic 3D-property MS-WHIM indexes, calculated interaction energies, isotropic surface area (ISA), electronic charge index (ECI), charge transfer for carbons (CT), Lewis basicity (LB), Lewis acidity (LA), maximum electrostatic potential (Vₘₐₓ), minimum electrostatic potential (Vₘᵢₙ), maximum local ionization energy (Iₘₐₓ₎, minimum local ionization energy (Iₘᵢₙ), conformational strain energy (ΔHₛₜᵣₐᵢₙ), molecular electrostatic potential (MEP) on Connolly molecular surface, local flexibility (Fr), flexibility index (Fb), chain flexibility (FO), occupied volume by a residue buried in globular protein, bulkiness defined as the ratio of the side-chain volume to its length, total energy (Eₜₒₜₐₗ), heat of formation (ΔH_{f}), energy of highest occupied molecular orbital (E_{HOMO}), energy of lowest unoccupied molecular orbital (E_{LUMO}), dipole moment (μ), polarizability (α), most positive partial charge on a hydrogen atom (qH+), most negative partial charge in the molecule (q−), partial charges on the oxygen and carbon atoms (qC, qO) of the carbonyl group, integrated molecular transform (FTm), integrated electronic transform (FTe), Integrated charge transform (FTc), normalized molecular moment (Mn), electronic moment (Me), charge moment (Mc), absolute electronegativity (EN), absolute hardness (HA). Such descriptors convey information on ligand-binding features in a biological target protein such as transmembrane receptors including 7TM receptors.

The physicochemical descriptors of amino acids or of amino acid side chains can also be obtained from principal component analysis (PCA) of the above-mentioned physicochemical descriptors, e.g. such as principal properties z-scales derived from collections of experimental data or with additional theoretical descriptors, MS-WHIM 3D-description matrices reflecting structural and electronic features of molecules, t-scores from interaction energies calculated with program GRID, and other combinations of descriptors mentioned above. C.f. Priolo et al., J. M. Journal of Molecular Catalysis B: Enzymatic (2001) 15, 177-189, Lejon et al., Journal of Peptide Science (2001) 7, 74-81, Zaliani et al., Journal of Chemical Information and Computer Sciences (1999) 39, 525-533, Matter, H. Journal of Peptide Research (1998) 52, 305-314, Sandberg et al, Joumal of Medicinal Chemistry (1998) 41, 2481-2491, Collantes and Dunn, Journal of Medicinal Chemistry (1995) 38, 2705-13, Norinder, UIf. Peptides (New York, NY, United States) (1991) 12, 1223-7, Hellberg and Kem. International Joumal of Peptide & Protein Research (1990) 36, 440-4, Skagerberg et al. Journal of Chemometrics (1990) 4, 241-53, Hellberg et al. Journal of Medicinal Chemistry (1987) 30, 1126-1135. In other words, In the methods according to the present invention wherein step v) is included, a simplified measure of the physicochemical properties of the binding site is obtained from principal component analysis (PCA) of the physicochemical descriptors.

Each residue type may be assigned as many physicochemical descriptors as decided, providing additional details of chemical features of the binding site of interest. In the following, a bitmap for a given selection of binding site residues is denoted F. Other descriptors used in the references cited herein may be chosen or combinations of these or novel descriptors reflecting physicochemical properties of amino acids relevant for ligand receptor interactions may be selected.

The physicochemical descriptors according to the present invention may also include dummy parameters or indicator variables, e.g. 1 and 0. Said indicator variables may denote the absence or the presence of aromatic side chains, hydrophobic side chains, negatively charged side chains, positively charged side chains, polar side chains, hydrogen-bond donating side chains, hydrogen-bond accepting side chains and/or other selected features.

The binding site classification procedure using for example binary codes is illustrated in FIG. 3.

In this example, a normalised string of bits, 0 or 1 representing chemical features of the binding site residues are generated. A set of five bits are assigned to each amino acid residue specifying the absence 0 or presence 1 of a certain chemical feature or characteristics. In this example the indicator variables correspond to the presence (TRUE=1) or absence (FALSE=0) of hydrophobic, aromatic, positively charged, negatively charged or polar features. For example, a tyrosine residue using such indicator variables will be represented by the bitmap fingerprint 1 1 0 0 1 (hydrophobic-aromatic-absent-absent-polar). The mapping process of physicochemical descriptors into a string containing information of all selected amino acids is usually carried out by conventional computerized methods. Certain chemical features may be considered more or less important than others, and weighted accordingly in the binding site classification. The present invention therefore describes a method wherein step v) is included and the physicochemical descriptors are weighted in step v).

An embodiment of the invention uses pseudo-sequences comprising at the most 50 amino acids obtained from at the most 12 amino acid residues per 7TM helix or extracellular loops, sequential or non-sequential, which are associated with physicochemical descriptors reflecting hydrophobic, electronic, steric, and hydrogen bonding properties. A specific embodiment of the invention uses pseudo-sequences comprising at the most 40 amino acids obtained from at the most 8 amino acid residues per 7TM helix or extracellular loops, sequential or non-sequential, which are associated with physicochemical descriptors reflecting hydrophobic, electronic, steric, 5 and hydrogen bonding properties. A preferred embodiment of the invention uses pseudo-sequences comprising at the most 30 amino acids obtained from at the most 6 amino acid residues per 7TM helix or extracellular loops, sequential or non-sequential, which are associated with theoretically derived physicochemical descriptors reflecting hydrophobic, electronic, steric, and hydrogen bonding properties.

Similarity Scores

It is desirable to quantify how similar a given receptor binding site or subsite is to other receptor binding sites and or subsites. Here we apply a number of different similarity measures to rank binding sites and their corresponding bitmaps. The measures are chosen due to their capabilities to handle large data sets and to iteratively, if needed, allow the investigation of relationships between combinations of different subsites or binding sites. The measures could handle different types of descriptors described herein and may be based upon a pattern recognition method, a Principal Component Analysis (PCA) reducing the number of descriptors to a few principal components, a Tanimoto Similarity Measure, a Tversky Similarity Measure or a Euclidian Distance Measure as described in Press, W. H; Flannery, B. P.; Teukolsky, S. A.; Vettering, W. T. Numerical recipes: The art of scientific computing; Cambridge University Press: 1986. The present invention relates to methods, wherein the generation of a similarity score in step v) is based upon a pattern recognition method. In an embodiment of the methods according to the present invention, the generation of the similarity score involves a Principal Component Analysis (PCA) reducing the number of descriptors to a few principal components.

The similarity measure applied are the Tanimoto Coefficient TC, Tversky similarity TS, 30 and an Euclidian distance d(F1,F2) defined below.

Tanimoto Similarity Measure:

The Tanimoto coefficient between two bitmaps F1 and F2 is defined as
TC=BC/(B1+B2−BC)
Here B1 and B2 are the numbers of 1's in F1 and F2 respectively and BC is the number of 1's in common between F1 and F2. TC is a value between 0 and 1. If TC=1 F1 and F2 are identical. If TC=0, F1 and F2 have no TRUE=1 occasions in common. In a further embodiment of the methods according to the present invention the generation of the similarity score in step v) (above) is based upon a Tanimoto Similarity Measure: TC=BC/(B1+B2−BC).
Tversky Similarity Measure:

The Tversky coefficient between two bitmaps F1 and F2 is defined as
TS=BC/(α* B1Unique+β*B2Unique+BC)
Here B1Unique and B2Unique are the number of unique 1's in F1 and F2 respectively. α and β are constants used to weight prototype and variant features. When α=β=1, this measure produces a symmetrical similarity metric identical to TC. In a still further embodiment of the methods according to the present invention, the generation of the similarity score in step v) is based upon a Tversky Similarity Measure: TC=BC/(α* B1 Unique+β*B2Unique+BC), wherein α are prototype features and β variant features.
Euclidian Distance Measure

The Euclidian distance represents the geometric distance between the bitmaps F1 and F2
d(F1,F2)=sqrt (F1−F2)²
where F1 and F2 are vectors in a N dimensional space. In the situation where physicochemical descriptors are used, F1 and F2 are no longer bit strings but string containing physicochemical descriptors representing the binding site residues of interest. In yet another embodiment of the methods according to the present invention, the generation of the similarity score in step v) is based upon Euclidian Distance Measure: d(F1,F2)=sqrt (F1−F2)².
Ranking of 7TM Receptors

A ranking of the 7TM receptors based on the physicochemical properties of their binding sites may be obtained, which gives a good indication of the similarity between them. In certain cases this is important, and in such cases, step vi) (above) is included.

The ranking with respect to the physicochemical properties assigned to the aligned pseudo-sequence is based upon similarity scores obtained according to the procedures described above, or from distances between coordinates in a Principle Component (PC) n-dimensional space, but it may also be based upon a 2- or 3-dimensional graphical representation. In the latter case, visualisation of the relationship and similarities between 7TM receptors is simplified.

Examples of receptors where sequence alignment and the physicogenomics approach give comparable relationships between 7TM receptors are typically illustrated by certain receptors with subclasses such as the neurokinin NK1 to NK4 receptors and muscarinic M1 to M5.

Thus, a model using theoretical descriptors will rank the receptors closest to the muscarinic M3 as M5 (3.4), M2 (3.7), M1 (3.9) and M4 (4.3), which is in accordance with findings that muscarinic antagonists are in principle fairly subtype-unselective. Likewise, the same model ranks the receptors closest to the neurokinin NK1 as NK3 (3.3), NK4 (3.3) and NK2 (3.6), followed by Adenosine A3R (3.6).

In contrast, the same model applied to histamine H2 will rank the closest receptors as adrenergic b1 (3.6) and b3(3.7), whereas the closest histamine receptor is more remote, i.e. histamine H1 (4.3) and the remaining ones are even further away but very close to each other, i.e. H3 (5.5) and H4 (5.5).

The same model applied to GRP44 (CRTH2) discussed previously will rank the closest receptors as angiotensin AT2 (2.9), chemokine-like receptor 1 (3.1), bradykinin B2 (3.4), Chemokine Receptor type 10 (3.6), Chemokine Receptor 1 (3.6), and angiotensin AT1 (3.7), which where not identified in the phylogenetic tree as close neighbours.

In one embodiment, the amino acid residues, up to six per helix, are selected from TM-III, TM-IV, TM-V, TM-VI and TM-VIII to form the following pseudo-sequences, which are used in the alignment. The following rank order of the similarity of the receptors can be obtained by implying the given set of amino acids associated with theoretically derived physicochemical descriptors reflecting hydrophobic, electronic, steric, and hydrogen bonding properties:

| | | |
|---|---|---|
| Receptor: | Pseudosequence | Ranking |

| | | |
|---|---|---|
| GP44_HUMAN | HSFFMFNTYAKFAWYHSEALTA | 1 |
| AG22_HUMAN | FGLTMFSSTAKNGWFHTDALIG | 2 |
| CML1_HUMAN | SNLIMFLSSTRFGWYHNELLTA | 3 |
| BRB2_HUMAN | VNISLYLSMNLNGWFQTDTTSA | 4 |
| CKRA_HUMAN | ISYSFHLAAAQVGQYSLDTLSA | 5 |
| C3X1_HUMAN | TTFFFFVAQNTNGWYNIETLEA | 6 |
| AG2R_HUMAN | ASVSLYASAGKNGWHQTDVMIA | 7 |

The use of lead structures might be based on in silico searches of specific scaffolds identified, on a pharmacophore model derived from these compounds, on in silico searches of such pharmacophore model, on design and synthesis of chemical libraries encompassing specific scaffolds identified, on a pharmacophore model derived from these compounds to design and/or construct chemical libraries containing novel chemical features compatible with the pharmacophores, on a pharmacophore models derived from these compounds to specifically design and synthesise novel ligands or on other common technologies used in drug design. The present invention also relates to the use of a pharmacophore as described herein for in silico screening, for construction of a library or for design of a ligand.

Having compared and ranked the 7TM receptors to each other by a suitable computerised mathematical model based on the relevant binding site and associated physicochemical descriptors of amino acid residues occupying the binding site, one can also identify 7TM receptors with binding properties similar to a given receptor and use that information to facilitate the drug design process.

For example the methods of the present invention allow identification of receptors, which are likely to cause a selectivity problem during drug development of a drug interacting with a given receptor. These potentially interfering receptors could be subject to directed counter-screens, reducing the need to screen compounds very broadly on a large number of receptors in the drug discovery and development process. The present invention relates to the use of the methods described herein to identify receptors, which are likely to cause a selectivity problem during drug development of a drug interacting with a given receptor.

Analogously to the utilization of the method to identify similarities in binding sites, the same principle can be applied to identify differences in subsites of binding sites between 7TM receptors as means to improve receptor selectivity of a drug towards a given 7TM receptor. The information regarding where significant differences exist in subsites between related receptors can be used in the design of ligands with improved receptor selectivity of a drug towards a given 7TM receptor.

### LEGENDS TO FIGURES

FIG. 1 illustrates the conventional phylogenetic analysis of the GPR44 (CRTH2) receptor,

FIG. 2.1 shows a schematic depiction of the secondary structure of a rhodopsin-like 7TM receptor with one or two conserved, key residues highlighted in each transmembrane segment: AsnI:18; AspII:10; CysIII:01 and ArgIII:26; TrpIV:10; ProV:16; ProVI:15; ProVII:17,

FIG. 2.2 shows how the transmembrane segments are generically numbered based on of the key residues present in the family B class of receptors,

FIG. 3 shows the binary 5-digit codes used to indicate absence or presence of physicochemical descriptors.

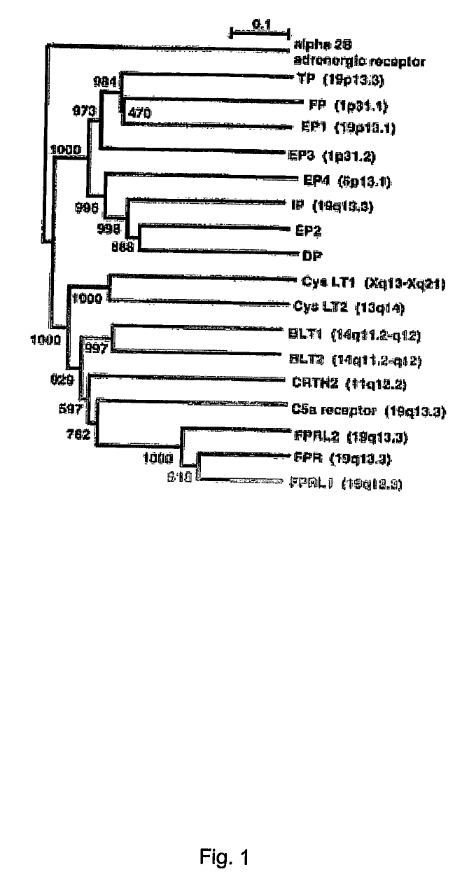

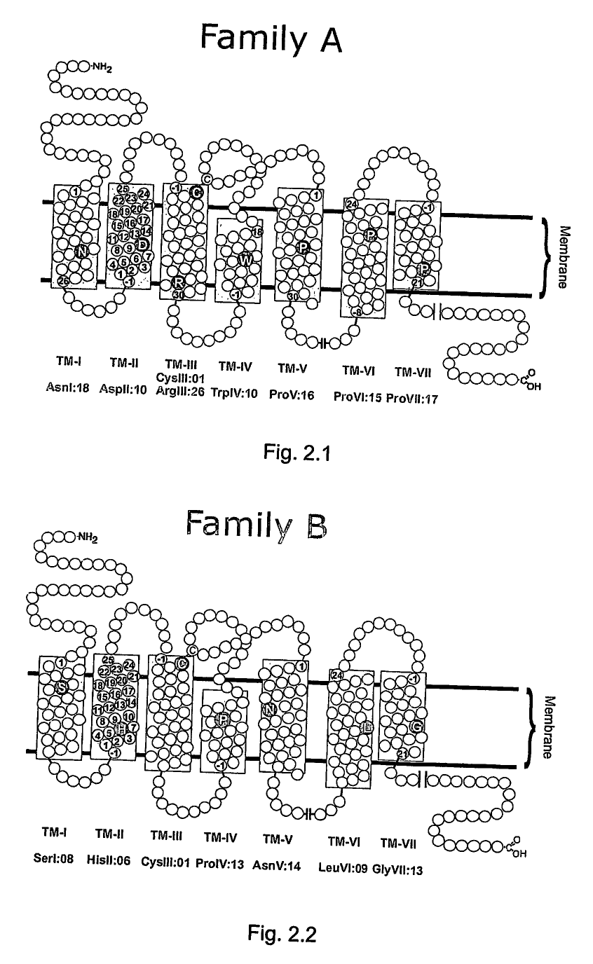

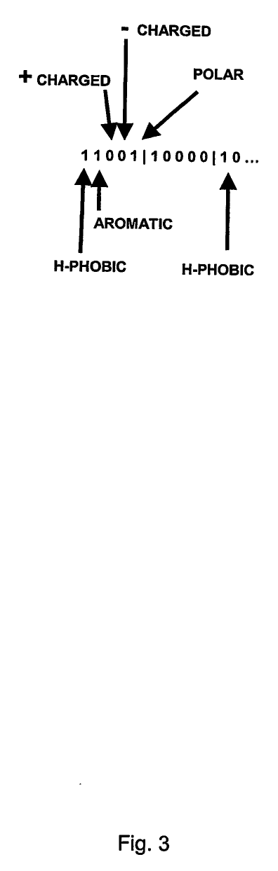

The following example is included for illustrative purposes and is not intended to limit the invention in any way.

### EXAMPLE

A model using theoretical size and electronic descriptors ranked the angiotensin AT2 and angiotensin AT1 receptors to be closely related to GRP44 (CRTH2) with respect to ligand-binding features in the binding site. Accordingly, among identified ligands, the known AT1 antagonist candesartan was found to inhibit [³H]PGD2 of GRP44 with an IC₅₀ of 2.1 μM. 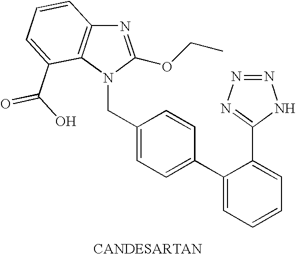
This example—describing the alignment procedure followed by amino acid selection and the other steps outlined above leading to the identification of AT1 as a GRP44-related receptor that serve as a source of discovering lead molecules for the new target GRP44 that can be used for in silico screening or design of focused chemical libraries—can analogously be applied to other receptors of interest.

1. A pseudo-sequence method for comparing a first 7TM receptor with one or more further 7TM receptors with respect to the physicochemical properties of selected amino acid residues of their binding sites, the method comprising the steps of:
i) optionally, aligning part of or all of the amino acid sequence of the first 7TM receptor with part of or all of the amino acid sequence of the one or more further 7TM receptors,
ii) selecting, in a sequential or non- sequential order, at the most 12 amino acid residues per helix and/or extracellular loops, which are involved in one or more binding sites of each 7TM receptor,
iii) forming a pseudo-sequence comprising at the most 50 amino acid residues from the selected sequential or non-sequential amino acid residues,
iv) for each 7TM receptor assigning one or more physicochemical descriptors to the amino acid residues of the selected amino acid pseudo-sequence involved in one or more binding sites,
v) optionally, for each 7TM receptor mathematically manipulating the physicochemical descriptors of step iv) to obtain a simplified measure of the physicochemical properties of the binding site,
vi) for each 7TM receptor generating a similarity score as defined herein by comparing the physicochemical descriptor or, if relevant, the simplified measure for the first 7TM receptor with the physicochemical descriptors or, if relevant, the simplified measures for the one or further 7TM receptors,
vii) optionally, ranking the 7TM receptors with respect to the physicochemical properties of their binding sites according to the similarity scores obtained in step vi).

2. A method according to claim 1, wherein the comparison is made without using data related to binding affinity of a ligand to a 7TM receptor.

3. A method according to claim 1 for classifying 7TM receptors according to the physicochemical properties of their binding sites.

4. A method according to claim 3, wherein the classification is made without using data related to binding affinity of a ligand to a 7TM receptor.

5. A method according to claim 1, wherein step ii) as defined in claim 1 comprises selecting, in a sequential or non-sequential order, at the most 11 amino acid residues per helix and/or extracellular loops, which are involved in one or more binding sites of each 7TM receptor.

6. A method according to claim 1, wherein step iii) as defined in claim 1 comprises forming a pseudo-sequence comprising at the most 50 amino acid residues from the selected sequential or non-sequential amino acid residues.

7. A drug discovery method for identifying ligands, which bind to a first 7TM receptor and potentially bind to one or more further 7TM receptors, the method comprising the steps of i) to vii) as defined in claim 1 and the further steps of viii) selecting from one to about 100 further 7TM receptors which have the closest similarity scores to the first 7TM receptor,
ix) identifying ligands which potentially bind to those further OTIS receptors selected in step vii) by selecting ligands that bind to the first 7TM receptor.

8. A drug discovery method for identifying ligands which bind to a first 7TM receptor and to one or more further 7TM receptors, the method comprising the steps of i) to vii) as defined in claim 1 and the further steps of:
viii) selecting from one to about 100 further 7TM receptors which have the closest similarity scores to the first 7TM receptor,
ix) screening ligands that bind to the first 7TM receptor against the selected 7TM receptors of step viii).

9. A drug discovery method for identifying a potential lead compound for a first 7TM receptor, the method comprising the steps of i) to vii) as defined in claim 1 and the further steps of
viii) selecting from one to about 100 further 7TM receptors which have the closest similarity scores to the first 7TM receptor,
ix) identifying ligands that bind to said one or more further 7TM receptors to construct a library including a potential lead compound for the first 7TM receptor.

10. A drug discovery method for identifying a lead compound for a first 7TM receptor, the method comprising the steps of i) to vii) as defined in claim 1 and the further steps of
viii) selecting from one to about 100 further 7TM receptors which have the closest similarity scores to the first 7TM receptor,
ix) identifying ligands that bind to said one or more further 7TMI receptors to construct a library, and
x) screening said library against the first 7TM receptor to identify a lead compound for the first 7TM receptor.

11. A drug discovery method for constructing a pharmacophore model for a first 7TM receptor, the method comprising the steps of i) to vii) as defined in claim 1 and the further steps of
viii) selecting from one to about 100 further 7TM receptors which have the closest similarity scores to the first 7TM receptor,
ix) identifying ligands that bind to said one or more further 7TM receptors to construct a pharmacophore model.

12. A drug discovery method according to claim 10, wherein the first 7TM receptor is one for which no ligands have been identified.

13. A drug discovery method according to claim 10, wherein the first 7TM receptor is an orphan receptor.

14. A method according to claim 1, wherein from one to 50 further 7TM receptors is/are selected in step viii).

15. A method according to claim 1, wherein from one to 25 further 7TM receptors is/are selected in step viii).

16. A method according to claim 1, wherein from one to 15 further 7TM receptors is/are selected in step viii).

17. A method according to claim 1, wherein the method is executed by a computer under the control of a program and the computer includes a memory for storing said program.

18. A method according to claim 1, wherein step i) is included and the alignment is based on a model developed for 7TM receptors.

19. A method according to claim 18, wherein the 7TM receptors are Class A, Class B, Class C or taste receptors.

20. A method according to claim 1, wherein step i) is included and the alignment is made with respect to transmembrane positioning of α-helices of 7TM receptors.

21. A method according to claim 1, wherein the binding site includes amino acid residues located in one or more extracellular loops of the 7TM receptors.

22. A method according to claim 1, wherein the binding site includes amino acid residues located in one or more subsites of the binding site and in one or more extracellular loops of the 7TM receptors.

23. A method according to claim 1, wherein the physicochemical descriptors reflect 7TM receptor-ligand interaction features of the amino acid residues.

24. A method according to claim 1, wherein the physicochemical descriptors are chosen to reflect hydrophobic, electronic, steric, hydrogen bonding or other properties of the amino acid residues.

25. A method according to claim 1, wherein the physicochemical descriptors reflect 3-dimensional features of the amino acid residues.

26. A method according to claim 1, wherein the physicochemical descriptors are selected from descriptors used in quantitative structure-activity relationships (QSAR), Principle Component Regression (PCR) and Partial Least-Squares (PLS) analysis of peptides.

27. A method according to claim 23, wherein the physicochemical descriptors are selected from molecular weight (MW), van der Waals volume, van der Waals radius, molar refractivity (MR), STERIMOL parameters (L, B₁, B₅), Parachor (Pᵣ), polar surface area, non-polar surface area, total surface area, ionisation constant (PK_{COOH}, PK_{NH2}), isoelectric point, net charge at pH 7, partition coefficient (log P), calculated partition coefficient (clog P, Prolog P, Maclog P), distribution coefficient (log D), TLC retention time, HPLC retention time, HPLC capacity factor log k, ¹H NMR chemical shift, ¹³C NMR chemical shift, steric and electrostatic 3D-property MS-WHIM indexes, calculated interaction energies, isotropic surface area (ISA), electronic charge index (ECI), charge transfer for carbons (CT), Lewis basicity (LB), Lewis acidity (LA), maximum electrostatic potential (Vₘₐₓ), minimum electrostatic potential (Vₘᵢₙ), maximum local ionization energy (Iₘₐₓ), minimum local ionization energy (Iₘᵢₙ), conformational strain energy (ΔHₛₜₐᵢₙ), molecular electrostatic potential (MEP) on Connolly molecular surface, local flexibility (Fr), flexibility index (Fb), chain flexibility (FO), occupied volume by a residue buried in globular protein, bulkiness defined as the ratio of the side-chain volume to its length, total energy (Eₜₒₜₐₗ), heat of formation (ΔH_{f}), energy of highest occupied molecular orbital (E_{HOMO}), energy of lowest unoccupied molecular orbital (E_{LUMO}), dipole moment (μ), polarizability (a), most positive partial charge on a hydrogen atom (qH+), most negative partial charge in the molecule (q−), partial charges on the oxygen and carbon atoms (qC, qO) of the carbonyl group, integrated molecular transform (FTm), integrated electronic transform (FTe), Integrated charge transform (FTc), normalized molecular moment (Mn), electronic moment (Me), charge moment (Mc), absolute electronegativity (EN), absolute hardness (HA).

28. A method according to claim 17, wherein the physicochemical descriptors include indicator variables.

29. A method according to claim 28, wherein the indicator variables denote absence or presence of aromatic side chains, hydrophobic side chains, negatively charged side chains, positively charged side chains, polar side chains, hydrogen-bond donating side chains, hydrogen-bond accepting side chains and/or other selected features.

30. A method according to claim 1, including step v), wherein the physicochemical descriptors are weighted in step v).

31. A method according to claim 1 including step v), wherein a simplified measure of the physicochemical properties of the binding site is obtained from principal component analysis (PCA) of the physicochemical descriptors.

32. A method according to claim 1, wherein the generation of a similarity score in step vi) is based upon a pattern recognition method.

33. A method according to claim 1, wherein the generation of the similarity score involves a Principal Component Analysis (PCA) reducing the number of descriptors to a few principal components.

34. A method according to claim 1, wherein the generation of the similarity score in step vi) is based upon Euclidian Distance Measure: d(F1,F2)=sqrt (F1-F2)².

35. A method according to claim 28, wherein the generation of the similarity score in step v) is based upon a Tanimoto Similarity Measure: TC=BC/(B1+B2−BC).

36. A method according to claim 28, wherein the generation of the similarity score i in step v) is based upon a Tversky Similarity Measure: TC=BC/(α*B1 Unique+β*B2Unique+BC), wherein α are prototype features and β variant features.

37. A method according to claim 1, wherein the step vii) is included.

38. A method according to claim 1, wherein the similarity score or, if relevant, the ranking is based upon a 2- or 3-dimensional graphical representation.

39. Use of a pharmacophore according to claim 11 for in silico screening.

40. Use of a pharmacophore according to claim 11 for construction of a library.

41. Use of a pharmacophore according to claim 11 for design of a ligand.

42. Use of a method according to claim 1 to identify receptors, which are likely to cause a selectivity problem during drug development of a drug interacting with a given receptor.

43. Use of a method according to claim 1 to identify differences in subsites of binding sires between 7TM receptors as means to improve receptor selectivity of a drug towards a given 7TM receptor.
